(19) United States
(12) Patent Application Publication
(10) Pub. No.: US 2018/0164251 A1
(43) Pub. Date: Jun. 14, 2018

(54) Eddy Current Tester in Probe Head

(71) Applicant: CoreStar International Corporation, Irwin, PA (US)

(72) Inventors: David A. Hand, North Huntingdon, PA (US); Michael D. Coradi, Pittsburgh, PA (US)

(21) Appl. No.: 15/838,643

(22) Filed: Dec. 12, 2017

Related U.S. Application Data
(60) Provisional application No. 62/433,314, filed on Dec. 13, 2016.

(51) Int. Cl. G01N 27/90

(52) U.S. Cl. CPC G01N 27/9046; G01N 27/908; G01N 27/902

(57) ABSTRACT

In a system and method of eddy current testing, all analog portions of an eddy current tester are generated in a probe assembly that includes a coil module and a tester module, wherein the probe assembly is inserted into a tube under inspection. The tester module supplies to the coil module analog signals that induce eddy currents in the tube under inspection and receives from the coil module analog signals produced in response to the induced eddy currents. The tester module converts the received analog signals into digital data corresponding to the induced eddy currents. Digital data, control signals, and power and ground are sent over a cable that runs between the tester module and an interface module. The cable does not carry analog signals. The data can be converted into eddy current data that can be displayed on a display.

### CROSS REFERENCE TO RELATED APPLICATION

This application claims priority to U.S. Provisional Patent Application No. 62/433,314, entitled “Eddy Current Tester in Probe Head”, filed Dec. 13, 2016, the disclosure of which is incorporated by reference in its entirety.

### BACKGROUND OF THE INVENTION

### Field of the Invention

The present invention relates to eddy current nondestructive testing (NDT).

### Description of Related Art

A prior art eddy current nondestructive testing (NDT) system includes an eddy current tester, an eddy current probe head comprising coils of wire in various configurations, and a cable connecting the tester and the probe.

The eddy current tester generates analog electrical signals, usually sine waves, that are driven over a possibly lengthy cable to the probe head which includes coils of wire that produce magnetic fields in response to the analog signals. In the case of tubing inspection, the cable is used to insert the probe head into a metal tube to be inspected. The magnetic fields produced by the coils of wire in the probe interact with nearby electrically conducting materials, such as stainless steel, forming the tube being inspected. The fluctuating magnetic fields induce currents in the material known as eddy currents. These eddy currents in turn induce electric fields, known as back electromotive force (emf), in the probe coils. Defects in the material modify the eddy currents and cause the back emf to vary based on the type of defect and probe coil configuration. This interaction modifies the analog drive signals from the tester via induced currents that propagate back down the cable where they are measured by the tester. The tester demodulates the modified signals to determine phase and amplitude shifts caused by the magnetic field interaction with the material forming the tube being inspected. The tester converts the signals to digital eddy current data that can be processed. This processing is often done by another control computer via a network or other means. On some systems, the control computer is in the same housing as the tester.

The simplest kind of probe in tubing inspection is a bobbin probe that has two coils of wire that act as both driver and receiver coils. The tester measures back emf by measuring the impedance of the coils as they move down the length of the tube.

Array probes greatly enhance defect characterization by adding many more coils than a bobbin probe. A typical array probe includes a first set of coils (drive coils) that are used to supply magnetic fields to the tube and a second set of coils (receive coils) that are used to receive the back emf from the tube. Since it is not practical to fit enough wires for all of these coils in an analog cable, one or more analog multiplexers in the probe are used to direct the analog drive signals from the tester to one or more particular sets of drive coils in a given time period and to direct the back emf signals from one or more particular sets of receive coils to the tester in a given time period for processing. There are many variations of bobbin and array probes.

There are, however, numerous problems with such prior art NDT systems. For example, in tubing inspection, such as nuclear steam generators and other heat exchangers, the cable is often 30 meters long or more. The drive and back emf signals are often small and such a long cable introduces undesirable noise. The cable also acts like an antenna that can pick up undesirable environmental noise such as nearby welding or other activity. The cable is also a transmission line that can distort the drive and back emf signals. The effects of the cable are usually frequency dependent and can be difficult to compensate. The noise is exacerbated by the fact that the cable is bending and moving during testing, often at high speed. Some probe technologies have many sensor coils requiring numerous wires in the cable. This makes the cable very thick, bulky and costly. It also introduces crosstalk noise between the analog signals. Finally, each kind of probe needs a different kind of cable.

### SUMMARY OF THE INVENTION

Generally, provided are an improved apparatus and method for eddy current testing.

In a non-limiting embodiment or example, the present invention solves some or all of the above problems by moving all of the analog components of the prior art NDT system into a novel probe assembly. The analog drive signals can be generated in a tester module that is housed in the probe assembly and travel within the probe assembly a short distance to probe coils of a coil module which is also housed in the probe assembly. The analog signal response (i.e., back emf) of the probe coils (acting as receive coils) can be converted to digital signals via a receiver that includes analog to digital converters (ADC). The digital signals can be processed by the tester module into digital eddy current data that can be sent by the tester module through a cable to an interface module. The complete process of stimulating the probe coils, converting the analog eddy current response to digital eddy current data, and transmitting the resulting digital eddy current data, along with optional digital information such as time stamps, over the cable to the interface module can be referred to as acquiring a data sample.

In a non-limiting embodiment or example, in some cases the digital signals may only by partially processed (i.e. demodulated) into digital eddy current data by the tester module. The partially processed digital signals can be processed into final digital eddy current data by the interface module and/or a control module. A typical data sample will have digital eddy current data values corresponding to the eddy current response for each probe coil acting as a receive coil at each drive frequency.

In a non-limiting embodiment or example, the interface module can communicate with a control module via a digital control interface. The control module can be a computer, such as a PC and the like, connected to the interface module via the control interface that can use any suitable and/or desirable communication protocol, such as, without limitation, Ethernet. However, this is not to be construed in a limiting sense since any suitable and/or desirable communication protocol can be used.

In a non-limiting embodiment or example, since only power and digital data are sent over the cable to and from the tester module of the probe assembly, the problems discussed above with prior art NDT systems are avoided.

In a non-limiting embodiment or example, the advanced manufacturing techniques may be used in order to make the tester module small enough to fit into the probe assembly, which probe assembly can be as small as 12 mm in diameter. To this end, some chips, such as, for example, one or more analog-to-digital converter (ADC) chips and/or one or more digital-to-analog converter (DAC) chips, in bare die form may be required.

Further preferred and non-limiting embodiments or aspects are set forth in the following numbered clauses.

Clause 1: An eddy current tester comprises a probe assembly including: a plurality of coils; a first module; and an enclosure housing the plurality of coils and the first module, wherein the module includes a first processor or controller, a driver connected between the first processor or controller and a first subset of the coils, and a receiver connected between the first processor or controller and a second subset of the coils, and the enclosure is configured to be received in a tube under inspection; a second module including a second processor or controller; and a cable coupled between the probe assembly and the second module. The first processor or controller is operative: for receiving from the second processor or controller via the cable one or more digital command signals that cause the first processor or controller to control the driver to supply analog signals to the first subset of coils and that cause the first processor or controller to sample a digital output of the receiver corresponding to analog signals produced by the second subset of coils in response to the analog signals supplied to the first subset of coils; and for communicating to the second processor or controller via the cable digital data corresponding to the sampled digital output of the receiver, wherein the first subset of coils can be the same or different than the second subset of coils.

Clause 2: The eddy current tester of clause 1, wherein, when the enclosure is received in the tube under inspection, the supplied analog signals can induce eddy currents in the material forming the tube and the produced analog signals correspond to the induced eddy currents.

Clause 3: The eddy current tester of clause 1 or 2, wherein all analog signals for inducing eddy currents in a material and resulting from the induced eddy currents can be generated and produced in the probe assembly.

Clause 4: The eddy current tester of any one of clauses 1-3, wherein all electrical power used by the probe assembly can be provided to the probe assembly from a power supply of the second module via the cable.

Clause 5: The eddy current tester of any one of clauses 1-4, wherein in response to the one or more digital command signals from the second processor or controller, the first processor or controller can sample the digital output of the receiver one or more times.

Clause 6: The eddy current tester of any one of clauses 1-5, wherein in response to the one or more digital command signals from the second processor or controller, the first processor or controller can be operative for periodically sampling the digital output of the receiver a plurality of times.

Clause 7: The eddy current tester of any one of clauses 1-6, a length of the cable separating the probe assembly and the second module can be at least 10 meters.

Clause 8: The eddy current tester of any one of clauses 1-7, wherein the corresponding digital data comprises digital eddy current data.

Clause 9: The eddy current tester of any one of clauses 1-8, wherein the driver can include one or more DACs and the receiver can include one or more ADCs.

Clause 10: A method of eddy current testing comprising: (a) providing a probe assembly that includes a coil module and a tester module; (b) inserting the entire probe assembly into a tube under inspection; (c) supplying by the tester module to the coil module analog signals that induce eddy currents in the tube under inspection; (d) receiving by the tester module from the coil module analog signals produced in response to the induced eddy currents; and (e) converting by the tester module the received analog signals into corresponding digital data.

Clause 11: The method of clause 10, wherein step (e) can include the tester module converting the received analog signals into corresponding digital data periodically.

Clause 12: The method of clause 10 or 11, wherein step (e) can include the tester module converting the received analog signals into corresponding digital data aperiodically.

Clause 13: The method of any one of clauses 10-12, wherein step (c) can occur in response to the tester module receiving at least one digital command signal from a second module disposed outside of the tube via a cable that runs at least partially in the tube between the tester module and the second module.

Clause 14: The method of any one of clauses 10-13, can further include receiving the corresponding digital data at the second module from the tester module via the cable.

Clause 15: The method of any one of clauses 10-14, can further include processing, by the second module, the corresponding digital data into eddy current data corresponding to the induced eddy currents.

Clause 16: The method of any one of clauses 10-15, can further include processing the corresponding digital data into eddy current data corresponding to the induced eddy currents.

Clause 17: The method of any one of clauses 10-16, wherein the processing of the corresponding digital data into eddy current data can occur at least partially at the tester module.

Clause 18: The method of any one of clauses 10-17, wherein the processing of the corresponding digital data into eddy current data can occur at least partially at a second module disposed outside of the tube and coupled to the tester module via a cable that runs at least partially in the tube between the tester module and the second module.

Clause 19: The method of any one of clauses 10-18, wherein the tester module can include: one or more digital-to-analog converter (DAC) for inducing the eddy currents; one or more analog-to-digital convertor (ADC) for converting the received analog signal into the corresponding digital data; and a processor or controller for controlling the operation of the one or more DACs and the one or more ADCs and for processing digital outputs of the one or more ADCs into digital data and for communicating digitally with the second module disposed outside of the tube and coupled in communication with the tester module via a cable that runs at least partially in the tube between the tester module and the second module.

Clause 20: The method of any one of clauses 10-19, wherein electrical power for operation of the tester module can come via the cable from a power supply of the second module.

Clause 21: The method of any one of clauses 10-20, wherein electrical power for operation of the tester module can come from a power supply disposed outside of the tube via a cable that runs at least partially in the tube between the tester module and the power supply.

Clause 22: A method of eddy current testing comprising: (a) providing a probe assembly, including a first processor or controller and a plurality of coils, coupled in communication with a module, including a second processor or controller, via a cable; (b) inserting the probe assembly and a portion of the cable into a tube to be inspected while the module is disposed outside the tube; (c) in response to a command from the second processor or controller, the first processor or controller, via the plurality of coils, inducing eddy currents in the material forming the tube and acquiring data corresponding to the induced eddy currents; and (d) processing, by at least one of the first processor or controller and the second processor or controller, the acquired data into eddy current data.

Clause 23: The method of clause 22, can further include displaying the eddy current data on a display.

### BRIEF DESCRIPTION OF THE DRAWINGS

FIG. 1 is a perspective view of a non-limiting embodiment or example of a system for eddy current testing/inspection according to the principles of the present invention;

FIG. 2 is a generalized block diagram of the system shown in FIG. 1;

FIG. 3 is a detailed block diagram of the system shown in FIG. 1 for the case of an array probe;

FIG. 4 is a detailed block diagram of the system shown in FIG. 1 for the case of a bobbin probe;

FIG. 5 a perspective view of a non-limiting embodiment or example of the probe assembly of FIG. 1;

FIG. 6 is more detailed block diagram of a non-limiting embodiment or example of the tester module shown in FIGS. 1-4;

FIG. 7 is more detailed block diagram of a non-limiting embodiment or example of the interface module shown in FIGS. 1-4; and

FIG. 8 is a method according to the principles of the present invention.

### DESCRIPTION OF THE INVENTION

Various non-limiting examples will now be described with reference to the accompanying figures where like reference numbers correspond to like or functionally equivalent elements.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary examples or aspects of the invention. Hence, the specific examples or aspects disclosed herein are not to be construed as limiting.

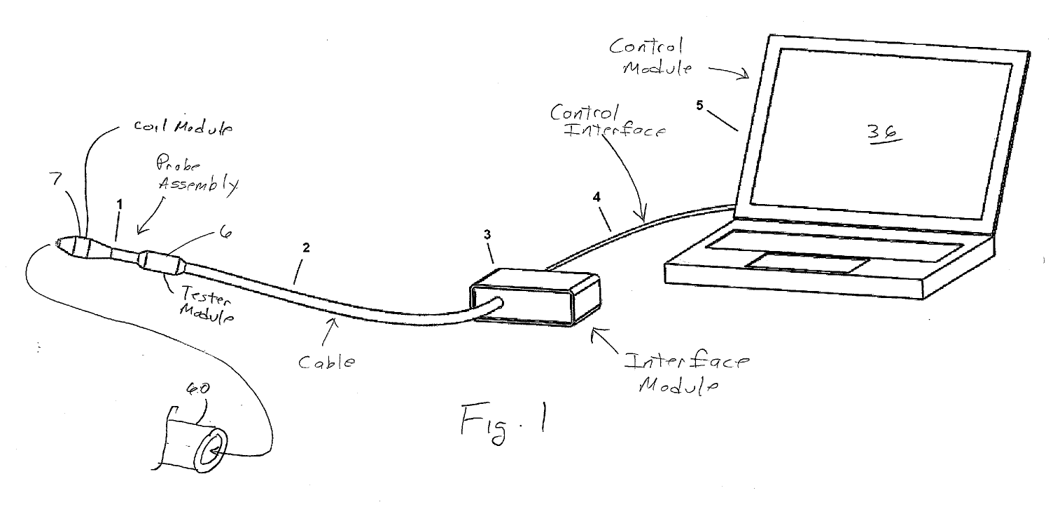

With references to FIGS. 1-3, in a non-limiting embodiment or example, an eddy current tester in accordance with the principles described herein includes analog components of the tester in a first or tester module 6 that is part of a probe assembly 1, whereupon said analog components are proximate coils 100 of a coil module 7 of probe assembly 1. In a non-limiting embodiment or example, tester module 6 can include a digital processor or controller 10 to generate the analog signals used to stimulate coils and measure the response of coils 100 to said stimulation. All of the remaining components of a conventional eddy current tester can be included in an interface module 3 which can be positioned remote, e.g., from a few meters to 10-35 meters or more, from probe assembly 1. Interface module 3 can interface with user I/O lines 9, the output of encoders 8, and a control module 5.

In a non-limiting embodiment or example, probe assembly 1 and interface module 3 are connected by a cable 2 which can be comprised of digital communication lines, one or more power and ground lines, and one or more optional control lines. This can reduce the bulk of cable 2 over prior art cables such that cable 2 can now fit on a small spool mounted either on a robot end-effector or a hand-held device. Probe assembly 1 may be driven into a tube 60 under inspection in a manner known in the art, e.g., via air pressure. A conventional probe pusher can also or alternatively be used as well when cable 2 has a stiff sheathing.

In a non-limiting embodiment or example, the digital communication lines of cable 2 can be full or half duplex serial data interfaces, such as RS-485 or Ethernet over twisted pair or coaxial, using one or more channels, but can also be optical fiber(s).

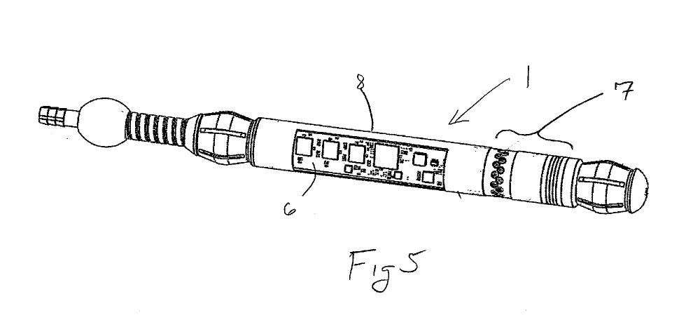

In a non-limiting embodiment or example, tester module 6 of probe assembly 1 can perform all of the analog functions of a prior art eddy current tester. For example, tester module 6 can generate analog electrical signals that go a short distance to a first subset of coils 100 (drive coils) of coil module 7, and can then measure the analog response of a second subset of coils 100 (receive coils) to eddy currents induced in the material forming tube 60 by the electrical signals provided to the drive coils by tester module 6. The analog response of the receive coils can be converted by suitable circuitry of tester module 6 into corresponding digital data that can be processed by tester module 6 into digital eddy current data and sent over cable 2 to interface module 3. In a non-limiting embodiment or example, the corresponding digital data can be processed partially by tester module 6 and partially by interface module 3 and/or a control module 5. An example of a probe assembly 1 including tester module 6 and coil module 7 enclosed in a housing 8 is shown in FIG. 5, wherein a portion of housing 8 is open for the purpose of illustrating tester module 6. However, this is not to be construed in a limiting sense since, in practice, housing 8 would be enclosed to avoid exposure of tester module 6.

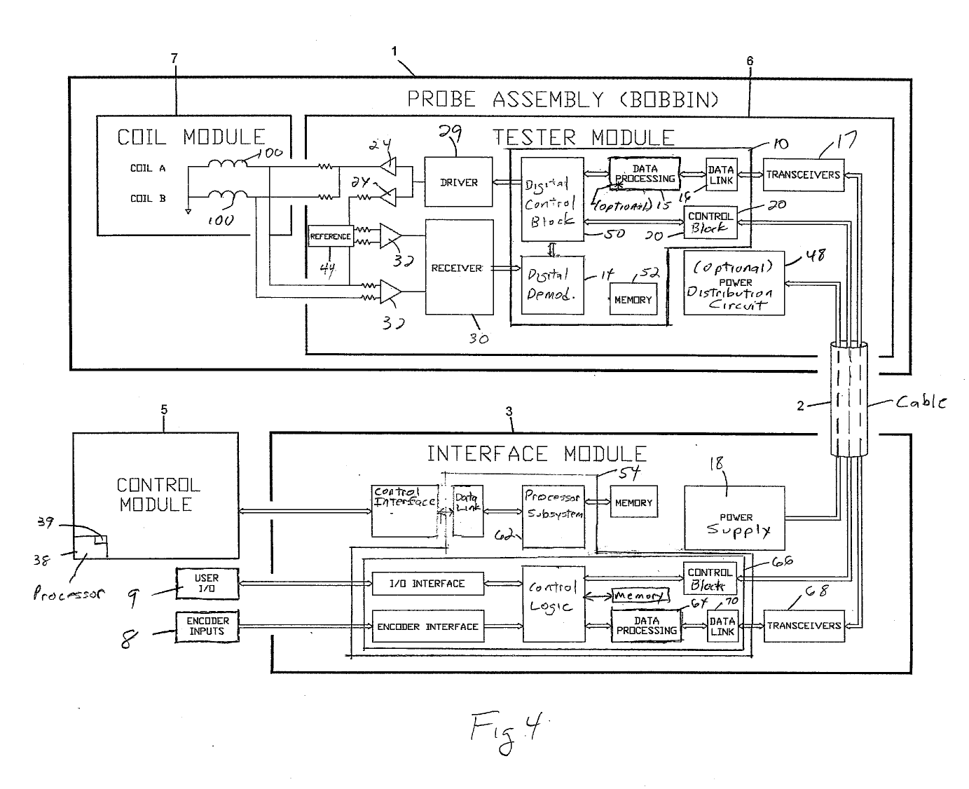

In a non-limiting embodiment or example, probe assembly 1 in accordance with the principles described herein enables cable 2 that can be used with any kind of probe assembly. Previously, the number of wires in a cable coupled to a prior art probe assembly depended upon the number of analog signals required by the probe coils of the prior art probe assembly. The present eddy current tester described herein enables probe assembly 1 with a large number of coils 100 to use the same cable 2 and interface module 3 as a simple bobbin probe which only has two coils (see FIG. 4, coil module 7) that are used as both drive and receive coils.

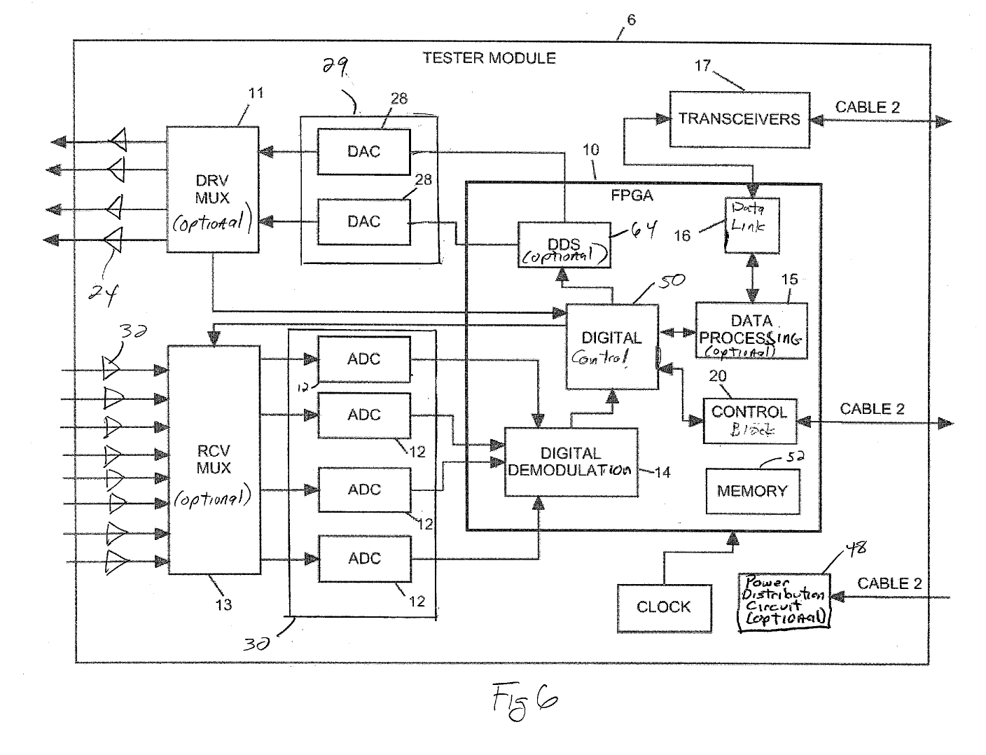

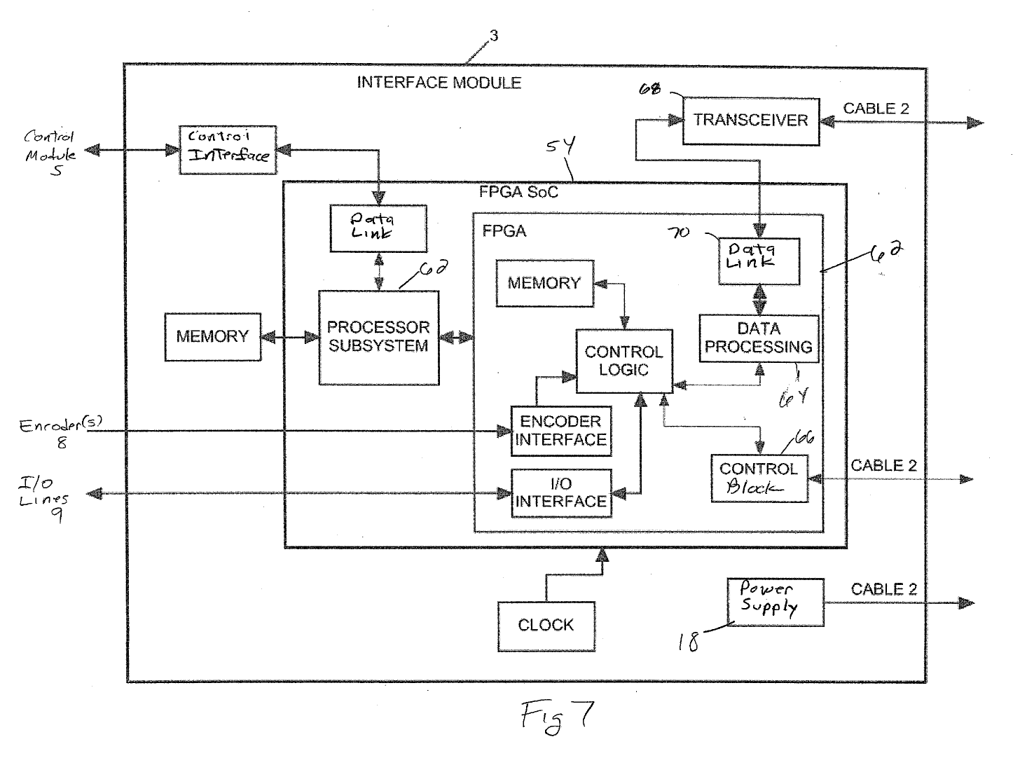

In a non-limiting embodiment or example, digital communication between tester module 6 and interface module 3, via cable 2, may use signal processing techniques, such as, without limitation, data compression, error detection, and/or correction algorithms. In a non-limiting embodiment or example, as shown in FIG. 6, data compression can be done in a data processing block 15 of digital processor or controller 10 of tester module 6. As shown in FIG. 7, said compressed data can be sent over cable 2 to interface module 3 and decompressed by a data processing block 64 of a processing subsystem 62 of a digital processor or controller 54 of interface module 3.

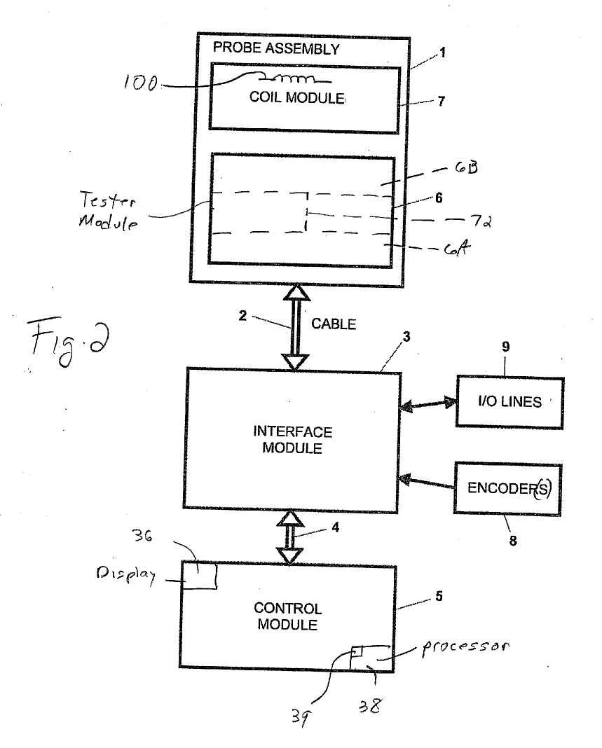

In a non-limiting embodiment or example, interface module 3 can send encoder information received from one or more encoders 8 to tester module 6 for distance based sampling, can provide power, via power supply 18, to tester module 6, and can interface between control module 5, e.g., a computer, and probe assembly 1. Interface module 3 may also be coupled to more than one probe assemblies 1 via a like number of cables 2. Interface module 3 may also be integrated into a probe pusher (not shown) that can move probe assembly 1 into and out of a tube 60 (FIG. 1) being inspected. While tester module 6 in FIGS. 2-6 is illustrated as a single module, it is envisioned that the circuitry comprising test module 6 may be included in multiple physical sub-modules. In a non-limiting embodiment or example, one of these sub-modules connected directly to cable 2 can be the master that would handle distributing configuration and other information to slave sub-modules as well as merging their data streams into a single stream sent over cable 2.

In a non-limiting embodiment or example, encoder information from encoders 8, used for position based sampling, can be sent via interface module 3 and cable 2 to tester module 6, either by a packet or packets on the digital communication lines comprising cable 2 or a separate control line of cable 2, indicating when to sample. In the case of the separate control line, interface module 3 can merge the actual encoder value for a given data sample into the data stream. In the case of a packet or packets, the encoder value can be included in one or more packets and included in a data sample by the tester module 6.

In a non-limiting embodiment or example, cable 2 can include one or more optional control lines that run between tester module 6 and interface module 3. For example, one control line can be used by tester module 6 to assert an interrupt telling interface module 3 that interface module 3 needs to process data. For example, interface module 3 might need to process a data sample that tester module 6 has acquired. The functions performed by the control line can optionally be done via messages sent over the digital communication lines of cable 2.

In a non-limiting embodiment or example, for probe assembly 1 with one or more rotating parts, such as a rotating pancake coil (RPC), tester module 6 can be included in the rotating part, along with probe assembly 1, whereupon no analog signals need to be sent over a slip rings to coils 100 of coil module 7.

In a non-limiting embodiment or example, one or more references 44 (FIG. 4) can be provided, each of which can utilize, in an example, a tuned resistor, inductor, capacitor (RLC) circuit to impedance match a receive coil 100 of coil module 7, and avoid saturating the analog input of receiver 30. In prior art eddy current test systems, impedance matching is done either by using a physical reference probe or a reference null via a separate digital-to-analog converter (DAC). The physical reference probe required an entire separate and identical probe located in a reference tube of the same material being inspected. A reference null suffers from loss of common mode noise rejection thus exhibiting much higher noise levels than a physical reference probe as well as requiring more circuitry. Utilizing an RLC circuit as a reference will not work with prior art eddy current test systems with analog signals sent over long cables since the inductive reactance of the cable is frequency dependent. This is why, in prior art eddy current test systems, a physical reference probe must have identical electrical characteristics to the test probe including the same cable length and type. By incorporating tester module 6 proximate to coil module 7 in probe assembly 1, the analog cable of the prior art eddy current testers can be eliminated and a simple passive RLC circuit can be used as a reference. An example of a reference 44 will be described hereinafter in connection with the bobbin probe assembly shown in FIG. 4.

In a non-limiting embodiment or example, examples of the types of probes that can comprise the eddy current test system shown in FIG. 1 include, simple bobbin; array probes; RPC probes; and remote field testing (RFT) probes.

In a non-limiting embodiment or example, interface module 3 can communicate with control module 5 via a digital interface 4, which may be wired and/or wireless, using digital communication such as PCI, Ethernet, Wi-Fi, or Bluetooth.

In a non-limiting embodiment or example, DC power to the tester modules 6 described herein can either be sent from a power supply 18 of interface module 3 to probe assembly 1 via separate wires of cable 2 for each voltage or a select set of voltages can be sent from power supply 18 of interface module 3 to probe assembly 1 with one or more other voltages being developed in probe assembly 1 via an optional power distribution circuit 48. DC power can also or alternatively be delivered on the same wires of cable 2 as digital communications to tester module 6, whereupon the DC power can be separated from the digital data using techniques similar to power over Ethernet (PoE).

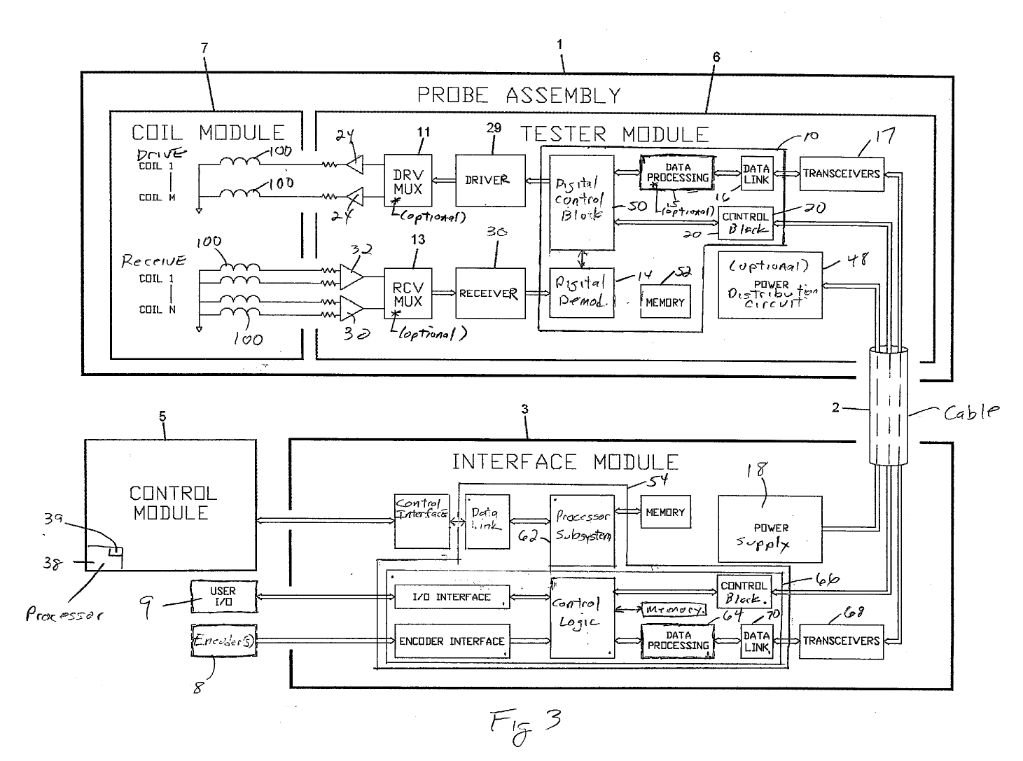

FIG. 3 is a block diagram of a non-limiting embodiment or example of the system shown in FIG. 1. In the system shown in FIG. 3, probe assembly 1 includes coil module 7 and tester module 6. Coil module 7 can comprise any type of arrangement of coils 100, such as bobbin, array, or RPC. In the example shown in FIG. 3, coil module 7 includes coils 100 of an array probe assembly.

In a non-limiting embodiment or example, tester module 6 can generate analog signals that drive the drive coils (coils 1-M) of coil module 7 and measure the response via the receive coils (coils 1-N) of coil module 7. Digital processor or controller 10 of tester module 6, coordinates this activity. Specifically, digital processor or controller 10, such as e.g., a microprocessor, an FPGA, or an ASIC, can receive configuration information over the digital communication lines of cable 2 from interface module 3. This configuration information can include the parameters, such as, without limitation, inspection frequencies, sample rate, and driving amplitudes, to be used for testing tube 60. Tester module 6 can use analog and/or digital demodulation. In a non-limiting embodiment or example, the various blocks of digital processor or controller 10 shown, for example, in FIG. 6, can be implemented in hardware, or software, or the combination of hardware and software.

In a non-limiting embodiment or example, tester module 6 can support dynamic reconfiguration. Tester module 6 can optionally store information regarding a number of configurations in a memory 52 of digital processor or controller 10 that enables tester module 6 to be dynamically configured based on variables such as a position of probe assembly 1 in tube 60. The stored configuration information can include information such as sample rate and drive frequencies.

In a non-limiting embodiment or example, digital processor or controller 10 can generate analog signals via a driver 29. In a non-limiting embodiment or example, shown in FIG. 6, driver 29 may include one or more digital-to-analog converters (DACs) 28, but may, alternatively, include direct digital synthesis (DDS) chips or other means for generating the analog signals.

In a non-limiting embodiment or example, for coil module 7 where the number of drive coils exceeds the number of outputs of the driver 29 of test module 6, an optional analog drive multiplexer 11 (labeled DRV MUX in FIGS. 3 and 6) can be provided. Under the control of digital processor or controller 10, drive multiplexer 11 can, in a manner known in the art, direct one or more analog signals output by driver 29, e.g., the DACs 28 of driver 29, to different drive coils (1-M) of coil module 7.

In a non-limiting embodiment or example, the response of the receive coils (1-N) of coil module 7 can be measured by a receiver 30. In a non-limiting embodiment or example, where required, an optional analog receive multiplexer 13 (labeled RCV MUX in FIGS. 3 and 6), operating under the control of digital processor or controller 10, can direct the outputs of different sets of receive coils (1-N) of coil module 7 to receiver 30 based on control signals from digital processor or controller 10. In a non-limiting embodiment or example, receiver 30 can include one or more analog-to-digital converters (ADCs) 12 for receiving the outputs of the receive coils (1-N) of coil module 7.

In a non-limiting embodiment or example, one or more amplifiers 24 can be disposed in the signal path between driver 29, in particular, one or more DACs of driver 29, and the drive coils (1-M). In a non-limiting embodiment or example, one or more amplifiers 32 can be disposed in the signal path between the receive coils (1-N) and receiver 30, in particular, one or more ADCs 12 of receiver 30. In the case of digital demodulation, the digital output(s) of the one or more ADCs 12 can be processed by a digital demodulation block 14 of digital processor or controller 10, which digital demodulation block 14 can demodulate the digital output of the one or more ADCs 12 and output digital eddy current data that can be read and processed by a digital control block 50 of digital processor or controller 10. In the case of analog demodulation, digital demodulator block 14 can be omitted or bypassed, and the demodulated digital output(s) of the one or more ADCs 12 can be read directly from the ADCs 12 by a digital control block 50 of digital processor or controller 10 and converted by digital control block 50 into digital eddy current data.

In a non-limiting embodiment or example, the digital eddy current data, and other information, such as, without limitation, time stamps and encoder position (provided to digital processor or controller 10 from encoder(s) 8 via interface module 3), can be transmitted from digital control block 50 of digital processor or controller 10 to interface module 3 via a data link 16 (e.g., an Ethernet MAC) of digital processor or controller 10 via digital communication lines of cable 2. This may involve a number of stages. In cases where the amount of data exceeds the bandwidth of the digital communication lines of cable 2, the data can be compressed in an optional data processing block 15 of digital processor or controller 10 before sending to a digital processor or controller 54 of interface module 3 via data link 16. In a non-limiting embodiment or example, digital processor or controller 54, e.g., a microprocessor, an FPGA, or an ASIC, of interface module 3 can be configured to decompress the compressed data. In a non-limiting embodiment or example, the various blocks of digital processor or controller 54 shown, for example, in FIG. 7, can be implemented in hardware, or software, or the combination of hardware and software.

In a non-limiting embodiment or example, it is also envisioned that the complete digital demodulation may be broken into phases with only part of the digital demodulation being performed by tester module 6. This part along with the part requiring further digital demodulation can be transmitted over cable 2 where the digital demodulation can be completed either by digital processor or controller 54 of interface module 3 or a processor 38 of control module 5. Error correction and detection techniques may also be used in order to transmit digital data on cable 2 without errors and detect errors if they occur. This can also be done by data processing block 15 of digital processor or controller 10.

In a non-limiting embodiment or example, data processing block 15 can send and receive digital information over cable 2 via a data link 16 and a transceiver 17. In a non-limiting embodiment or example, data link 16 can be an Ethernet MAC, but can, alternatively, take other forms such as, without limitation, a UART. Transceivers 17 and 68 (of tester module 6 and interface module 3, respectively) can provide the physical interface of digital data between data links 16 and 70, of tester module 6 and interface module 3, respectively, via cable 2.

In a non-limiting embodiment or example, a control block 20 of digital processor or controller 10 can be used for dispatching I/O signals to and from a control block 66 of digital processor or controller 54 of interface module 3. In a non-limiting embodiment or example, in the case of distance based sampling, digital processor or controller 54 of interface module 3 can assert a line in order to make digital processor or controller 10 of tester module 10 take a sample as opposed to sampling on even time increments. In a non-limiting embodiment or example, digital processor or controller 10 can assert a line to digital processor or controller 54 of interface module 3 to tell it to receive data or process other interrupts.

In a non-limiting embodiment or example, interface module 3 interfaces tester module 6 to control module 5. Control module 5 can be a host computer that includes a processor 38, a memory 39, and a display 36. In a non-limiting embodiment or example, control module 5 and interface module 3 can be in the same enclosure, in which case, control interface 4 can, for example, be a data bus. If control module 5 is a separate system located some distance from interface module 3, control interface 4 can be communications channel (wired, wireless, or the combination of wired and wireless) that can support any suitable and/or desirable communication protocol, such as, without limitation, Ethernet, Wi-Fi, or Bluetooth for communication between control module 5 and interface module 3. The exact nature of control module 5 is not relevant to the present disclosure.

In a non-limiting embodiment or example, interface module 3 can also be connected to receive the output of one or more encoders 8. Also or alternatively, interface module 3 can be connected to I/O lines 9 that connect interface module 2 to external users.

With reference to FIG. 4 and with continuing reference to all previous Figs., in some probes, such as a bobbin probe, the same physical coil(s) 100 of coil module 7 can be used as both drive coils and receive coils. FIG. 4 shows a block diagram of the special case of a bobbin probe assembly 1 that is similar to most respects to probe assembly 1 shown in FIG. 3, but which bobbin probe assembly 1 includes a reference 44 and less coils 100 than the array probe assembly 1 shown in FIG. 3.

In the prior art use of bobbin probes, it is desirable to have an absolute channel where a sensor coil of the probe is compared to a fixed reference. In a conventional, prior art eddy current tester, this can be done using either a second, duplicate physical probe as a reference probe or a special driver generating an equivalent signal to the reference probe. In the former case, the coil(s) of the reference probe is/are driven by the same driver as the coil(s) of the inspection probe. This, however, requires a complete second physical probe for the reference. The latter method (i.e., special driver) solves the need for a second physical probe but suffers from noise due to a lack of common mode rejection due to the use of two different drivers.

In a non-limiting embodiment or example, the bobbin probe assembly 1 shown, for example, in FIG. 4 overcomes both of these issues by the use of reference 44. In a non-limiting embodiment or example, reference 44 can include a toroidal inductor in order to avoid magnetic coupling to the surrounding. In this case, the same driver 29, e.g., DAC 28, can drive both the physical sensor coils 100 of coil module 7 and reference 44. The difference of the outputs of coils 100 operating as receive coils and reference 44 can be fed to ADCs 12 of receiver 30 which can generate the absolute channel. This is not possible in conventional, prior art eddy current testers since the cable carrying the analog signals acts as a frequency dependent transmission line. In a non-limiting embodiment or example, reference 44 can be tuned to only match the impedance of physical coils 100 of coil modules 7.

In a non-limiting embodiment or example, either example probe assembly 1 shown in FIG. 3 or FIG. 4 can be used for eddy current inspection of tubing (e.g., tube 60 in FIG. 1), such as those found in nuclear steam generators or other heat generator exchangers. Such tubing is often 1.25 centimeters to 2.5 centimeters in diameter. There are many tubes 60 that either example probe assembly 1 shown in FIG. 3 or FIG. 4 can be inserted into and then retracted. Eddy current data can be acquired for some or all of the length of each tube 60. A robotic manipulator can be used to position either example probe assembly 1 shown in FIG. 3 or FIG. 4 in alignment with a tube 60 to be inspected.

In a non-limiting embodiment or example, either example coil module 7 shown in FIG. 3 or FIG. 4 can be any type of eddy current probe, such as, for example, a bobbin, array, or RPC that includes any suitable and/or desirable number of coils 100. Each coil 100 can be used as a drive coil, a receive coil, or as both a drive and a receive coil depending on the type of probe assembly 1 said coil comprises. Tester module 6 may vary based on the coil module 7 being used. For example, the bobbin probe assembly 1 shown in FIG. 4 includes reference 44 whereas the array probe assembly 1 shown in FIG. 3 does not. Regardless of the probe assembly 1 being used, cable 2 and interface module 3 can be the same.

A typical bobbin probe can include two coils 100 both driven by the same signal, e.g., the same signal output by a DAC 28 of driver 29. The difference in the response of the two coils 100 generates a differential signal. An absolute signal is generated by taking the difference of one of the coils against a fixed reference provided by reference 44.

With reference to FIG. 6 and with continuing reference to all previously figures, digital processor or controller 10 of tester module 6 can, in a non-limiting embodiment or example, be a microprocessor, an FPGA, or an ASIC. In one non-limiting embodiment or example, digital processor or controller 10 can be an FPGA that includes or implements the illustrated blocks (hardware, software, or the combination of hardware and software) for processing data in the manner described herein. However, the use of a program microprocessor or an ASIC is also or alternatively envisioned. Via digital processor or controller 10, tester module 6 can generate the necessary digital signals to driver 29, which includes one or more DACs 28, to produce sine waves or composite sine waves, either directly or via a direct digital synthesis (DDS) block 64 of digital processor or controller 10. When used with a typical bobbin probe, driver 29 may only require one DAC 28. The analog output of each DAC 28 can be used to drive one or more coils 100 of coil module 7, either directly or via an amplifier 24.

In a non-limiting embodiment or example, the eddy current response of one or more coils 100 of coil module 7 can be read by digital control block 50 of digital processor or controller 10, either directly of via digital demodulator 14, using one or more high-speed ADCs 12. Digital control block 50 and the one or more ADCs 12 can be connected via high speed serial interface, such as an LVDS or JESD204, but the use of a parallel interface is also or alternatively envisioned.

In a non-limiting embodiment or example, for a bobbin probe assembly 1 (FIG. 4), reference 44 can be used for the absolute channel. Reference 44 can be a simple passive circuit designed to approximately match the impedance of one or more coils 100 when bobbin probe assembly 1 is in tube 60, wherein the material forming tube 60 influences the impedance of the one or more coils 100. In a non-limiting embodiment or example, reference 44 can be driven by the same DAC 28 as one or more coils 100 in order to maximize common mode noise rejection.

In a non-limiting embodiment or example, cable 2 of probe assembly 1 can include one or more power and ground lines. In addition, cable 2 can provide full or half duplex serial data transmission of digital data. In a non-limiting embodiment or example, cable 2 can used twisted pairs of wires and Ethernet or other serial standards. In a non-limiting embodiment or example, fast Ethernet 10/100-TX can be used since it only requires two twisted pairs for full duplex and one twisted pair for half duplex and can have cable lengths as long as 100 meters or more and can support 100 Mbit/second data rates. The use of other serial protocols, such as RS-485, is envisioned but they typically have trouble achieving the necessary throughput for cable 2 having a length of 30 meters or more. Ethernet typically uses magnetics to connect the Ethernet physical layer to the physical wires of cable 2. However, these magnetics can be quite large. An alternative is to use capacitive coupling which can use smaller components.

In a non-limiting embodiment or example, cable 2 can have one or more digital control lines. In a non-limiting embodiment or example, one control line can be used for distance based sampling. In this case, an encoder of the mechanism used to move probe assembly 1 into and out of a tube 60 under inspection, e.g., a probe pusher, can, via the encoder input 8 to interface module 3, cause interface module 3 to trigger tester module 6 to take an eddy current sample of tube 60 based on how far probe assembly 1 has moved instead of at even time increments. For example, digital processor or controller 54 can monitor, via an encoder input 8, encoder data output by an encoder and can signal digital processor or controller 10, via a control line, to acquire an eddy current sample of tube 60 based on the monitored encoder data, e.g., at one or more predetermined values of encoder data, at one or more predetermined increments of encoder data, etc. This can also or alternatively be done by a digital signal sent from digital processor or controller 54 to digital processor or controller 10 via the digital communication lines of cable 2.

In general, a bobbin probe assembly (e.g., shown in FIG. 4) provides limited information about defects of tube 60. For example, a bobbin probe assembly provides no information about the circumferential extent of a defect. An array probe assembly (e.g., shown in FIG. 3) solves this by adding additional coils, with a first subset of coils used as driver coils and with a second subset of coils used as receive coils. An array probe assembly may have one or more DACs 28 and four or more ADCs 12.

In a non-limiting embodiment or example, tester module 6 (FIG. 6) can use a microprocessor, an FPGA, or an ASIC for digital processor or controller 10. In a non-limiting embodiment or example, digital processor or controller 10 comprising an FPGA is described herein for the purpose of illustration and not of limitation. Digital processor or controller 10 can generate any necessary signals, typically sine waves or composite sine waves to drive DACs 28.

In a non-limiting embodiment or example, in the case of an array probe assembly 1 (FIG. 3) where the number of drive coils 100 exceeds the number of DACs 28, the outputs of DACs 28 can be fed to drive multiplexer 11 which can be controlled by digital processor or controller 10 in a manner known in the art to direct the signals output by DACs 28 to a number of drive coils 100 at a given time. Drive multiplexer 11 can be controlled by lines from digital processor or controller 10 that switch which drive coils 100 of module 7 are driven by the signals output by DACs 28 during a given time period.

In a non-limiting embodiment or example, the eddy current response of the material forming tube 60 can be read by digital processor or controller 10 using ADCs 12. Digital processor or controller 10 and ADCs 12 can be connected using a high-speed serial interface, but the use of a parallel interface is also envisioned.

In a non-limiting embodiment or example, in the case of an array probe assembly 1 (FIG. 3) where the number of receive coils 100 exceeds the number of ADCs 12, receive multiplexer 13 can be controlled by digital processor or controller 10 in a manner known in the art to enable the inputs of ADCs 12 to receive the outputs of different sets of coils 100 in different time period. Receive multiplexer 13 can be controlled under the control of digital processor or controller 10 via signals from digital processor or controller 10.

In a non-limiting embodiment or example, it is also envisioned that an array coil module 7 (FIG. 3) and a bobbin coil module 7 (FIG. 4) can be incorporated in the same probe assembly 1. This will require tester module 3 to include the hardware and related programming of both the bobbin and array coil modules 7 shown in FIGS. 4 and 3, respectively, and described above.

In a non-limiting embodiment or example, in some cases, probe assembly 1 must go around sharp bends in tube 60. In a non-limiting embodiment or example, the circuitry of tester module 6 can be incorporated into two or more physical sub-modules, e.g., sub-modules 6A and 6B shown in phantom in FIG. 2, which collectively define tester module 6, connected by one or more flexible cables 72, also shown in phantom in FIG. 2. In this example, one of the sub-modules can be the master and the other(s) slave(s). The master sub-module, e.g., sub-module 6A, can communicate with interface module 3. Each of one or more slave sub-module, e.g., sub-module 6B, can receive configuration information via digital communication with the master sub-module via flexible cable 72 and can send its acquired data to the master sub-module. The master sub-module can merge data from each sub-module and send it to interface module 3 for processing.

A common type of probe is a rotating pancake coil (RPC) probe. This uses a motor (not shown) to make coil module 7 and, hence, coils 100 spin in tube 60. For RPC probe assembly 1 made in accordance with principles described herein, tester module 6 can be placed inside of the rotating part of probe assembly 1 along with coil module 7. This can eliminate noise caused by the use of one or more slip rings to send analog probe signals between tester module 6 and coil module 7.

In a non-limiting embodiment or example, digital processor or controller 10 of tester module 6 can include non-volatile memory 52 that can be used to store software and information such as, for example, a serial number, model number, and/or calibration data. This information can be communicated to control module 5 when needed and can be used for automatic configuration and other purposes.

In a non-limiting embodiment or example, cable 2 can include a stiff sheathing to allow it to be used on a conventional probe pusher. This sheathing needs to be stiff so that it and either example probe assembly 1 shown in FIGS. 3 and 4 can be pushed into tube 60. In a non-limiting embodiment or example, a 30 meter cable 2 requires a large spool, typically about 40 centimeters in diameter and about 13 centimeters wide. This spool can be mounted on a system called a probe pusher with one or more motors to move either example probe assembly 1 shown in FIGS. 3 and 4 and a part of cable 2 into tube 60 and to retract said probe assembly 1 and the part of cable 2 from tube 60.

In a non-limiting embodiment or example, cable 2 described herein can have a thin flexible sheathing. The smaller number of wires that can be used with the tester module 6 and interface module 3 described herein, allows cable 2 to be much lighter and smaller in diameter than is possible with a conventional, prior art eddy current tester. For example, cable 2 with a thin flexible sheathing can now be fit on a much smaller spool can fit on a robotic end effector. Probe assembly 1 can then be driven into tube 60 via air pressure and retracted via a motor attached to the spool.

In a non-limiting embodiment or example, interface module 3 can be integrated with the probe pusher, either inside or outside the rotating spool. Interface module 3 can connect to control module 5, via control interface 4 which can be, for example, via a wired or wireless Ethernet. Control module 5 can include a display 36 for displaying eddy current data produced by processor or controller 10, processor or controller 54, or both in response to the eddy currents induced in the material forming tube 60.

A non-limiting example interface module 3 is shown in FIG. 7. In this non-limiting example, digital processor or controller 54 can be an FPGA system-on-chip (SoC) that can include a processor block 62, such as ARM. In this non-limiting example, digital processor or controller 10 can be an FPGA. Other possibilities for digital processor or controller 10, digital processor or controller 54, or both include a programmed microprocessor, a fast processor, such as a DSP, or a standalone FPGA or ASIC.

In a non-limiting embodiment or example, digital processor or controller 10 implemented with an FPGA 10 can interface to the cable 2 via a transceiver 17. It can handle all digital communication via the digital communication lines and/or the control lines of cable 2. Data processing block 15 of digital processor or controller 10 can be implemented in FPGA 10 including error detection and correction, data compression and decompression.

In a non-limiting embodiment or example, digital processor or controller 10 and/or digital processor or controller 54 are described for the purpose of illustration, not of limitation. Accordingly, digital processor or controller 10 and/or digital processor or controller 54 may include one or more blocks (hardware, software, or both) not illustrated or specifically described herein or exclude one or more blocks not required for an application. Accordingly, the described and illustrated examples of digital processor or controller 10 and/or digital processor or controller 54 are not to be construed in any manner as limiting this disclosure. To the contrary, the described and illustrated examples of digital processor or controller 10 and/or digital processor or controller 54 are for the purpose of describing preferred and non-limiting embodiment(s), example(s), or aspect(s) and are not to be construed as limiting this disclosure to any particular embodiment(s), example(s), or aspect(s).

As can be seen disclosed herein is an eddy current tester comprising a probe assembly 1 including a plurality of coils 100, a first module 6, and an enclosure 8 housing the plurality of coils 100 and the first module 6, wherein the first module 6 includes a first processor or controller 10 (e.g. a microprocessor, an FPGA (shown in FIG. 6), or an ASIC), a driver 29 (e.g., digital-to-analog (DAC) converter 28) connected between the first processor or controller 10 and a first subset of the coils 100, and a receiver 30 (e.g., at least one analog-to-digital converter (ADC) 12) connected between the first processor or controller 10 and a second subset of the coils 100. The enclosure 8 is configured to be received in a tube 60 under inspection. The eddy current tester includes a second module 3 (and optionally 5) including a second processor or controller 54 (e.g. a microprocessor, an FPGA (shown in FIG. 7), or an ASIC) and a cable 2 coupled between the probe assembly 1 and the second module 3 (and optionally 5). The first processor or controller 10 is operative for receiving from the second processor or controller 54 via the cable 2 one or more digital command signals that cause the first processor or controller 10 to control the driver 29 to supply analog signals to the first subset of coils 100 and that cause the first processor or controller 10 to sample a digital output of the receiver 30 corresponding to analog signals produced by the second subset of coils 100 in response to the analog signals supplied to the first subset of coils 100, and for communicating to the second processor or controller 54 via the cable 2 digital data corresponding to the sampled digital output of the receiver 30, wherein the first subset of coils can be the same or different than the second subset of coils.

When the enclosure 8 is received in the tube 60 under inspection, the supplied analog signals can induce eddy currents in the material forming the tube 60 and the produced analog signals can correspond to the induced eddy currents.

All analog signals for inducing eddy currents in a material and resulting from the induced eddy currents can be generated and produced in the probe assembly 1.

All electrical power used by the probe assembly 1 can be provided to the probe assembly 1 from a power supply 18 of the second module 3 (and optionally 5) via the cable 2.

In response to the one or more digital command signals, the first processor or controller 10 can sample the digital output of the receiver 30 one or more times.

In response to the one or more digital command signals, the first processor or controller 10 can be operative for periodically sampling the digital output of the receiver 30 a plurality of times.

A length of the cable 2 separating the probe assembly 1 and the second module 3 can be at least 10 meters.

In a non-limiting embodiment or example, the corresponding digital data can comprise digital eddy current data.

In a non-limiting embodiment or example, the corresponding digital data can be processed into digital eddy current data by the first module 6, or partially by the first module 6 and partially by the second module 3 (and optionally 5).

The driver 29 can include one or more DACs. The receiver 30 can include one or more ADCs.

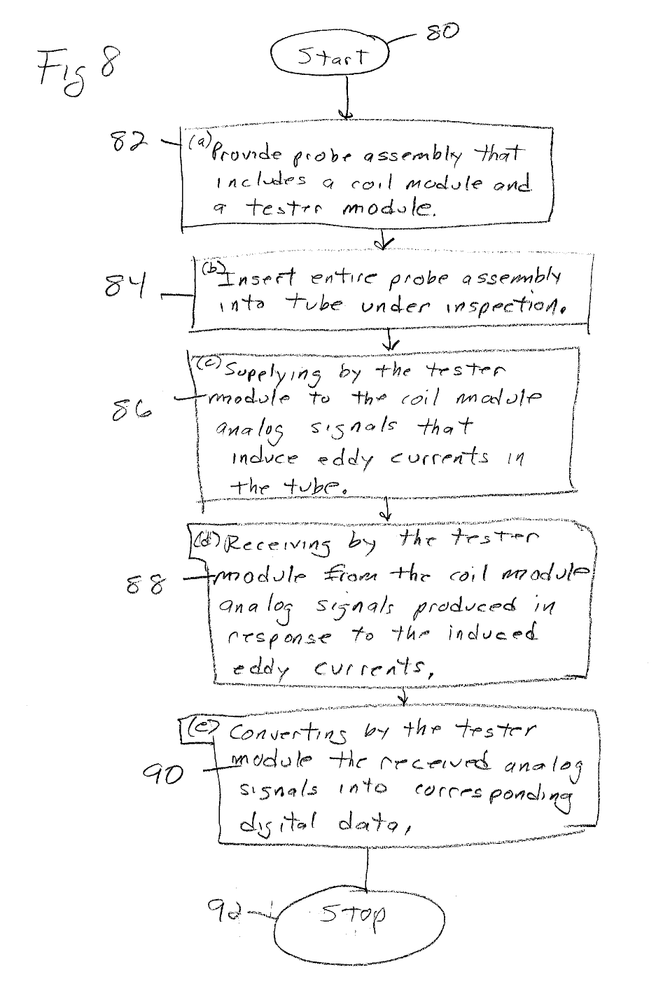

With reference to FIG. 8, also disclosed herein is a method of eddy current testing. The method includes advancing from start step 80 to step 82 which includes (a) providing a probe assembly 1 that includes a coil module 7 and a tester module 6. The method then advances to step 84 which includes (b) inserting the entire probe assembly 1 into a tube 60 under inspection. The method then advances to step 86 which includes (c) supplying by the tester module 6 to the coil module 7 analog signals that induce eddy currents in the tube 60 under inspection. The method then advances to step 88 which includes (d) receiving by the tester module 6 from the coil module 7 analog signals produced in response to the induced eddy currents. The method then advances to step 90 which includes (e) converting by the tester module 6 the received analog signals into corresponding digital data. Finally, the method advances to stop step 92.

Step (e) can include the tester module 6 converting the received analog signals into corresponding digital data periodically, aperiodically, or both.

Step (c) can occur in response to the tester module 6 receiving at least one digital command signal from a second module 3 (and optionally 5) disposed outside of the tube 60 via a cable 2 that runs at least partially in the tube 60 between the tester module 6 and the second module 3 (and optionally 5).

The method can further include receiving the corresponding digital data at the second module 3 (and optionally 5) from the tester module 6 via the cable 2.

The method can further include processing, by the second module 3 (and optionally 5), the corresponding digital data into eddy current data corresponding to the induced eddy currents.

The method can further include processing the corresponding digital data into eddy current data corresponding to the induced eddy currents.

The processing of the corresponding digital data into eddy current data can occur at least partially at the tester module 6.

The processing of the corresponding digital data into eddy current data can occur at least partially at a second module 3 (and optionally 5) disposed outside of the tube and coupled to the tester module 6 via a cable 2 that runs at least partially in the tube 60 between the tester module 6 and the second module 3 (and optionally 5).

The tester module 6 can include: a digital-to-analog converter (DAC) 28 for inducing the eddy currents; an analog-to-digital convertor (ADC) 12 for converting the received analog signal into the corresponding digital data; and a processor or controller 10 for controlling the operation of the DAC 28 and the ADC 12 and for communicating digitally with a second module 3 (and optionally 5) disposed outside of the tube 60 and coupled in communication with the tester module 6 via a cable 2 that runs at least partially in the tube 60 between the tester module 6 and the second module 3 (and optionally 5).

Electrical power for operation of the tester module 6 can be supplied via the cable 2 from a power supply 18 of the second module 3 (and optionally 5).

Electrical power for operation of the tester module 6 can be supplied from a power supply 18 disposed outside of the tube 60 and coupled to the tester module 6 via a cable 2 that runs at least partially in the tube 60 between the tester module 6 and the power supply 18.

Also disclosed is herein is a method of eddy current testing comprising: (a) providing a probe assembly 1, including a first processor or controller 10 and a plurality of coils 100, coupled in communication with a module 3 (and optionally 5), including a second processor or controller, via a cable 2; (b) moving the probe assembly 1 and a portion of the cable 2 into a tube 60 to be inspected while the module 3 (and optionally 5) is disposed outside the tube 60; (c) in response to a command from the second processor or controller, the first processor or controller 10, via the plurality of coils 100, inducing eddy currents in the material forming the tube 60 and acquiring data corresponding to the induced eddy currents; and (d) processing, by at least one of the first processor or controller 10 and the second processor or controller, the acquired data into eddy current data.

The method can further include displaying the eddy current data on a display 36.

Although the invention has been described in detail for the purpose of illustration based on what is currently considered to be the most practical preferred and non-limiting embodiments, examples, or aspects, it is to be understood that such detail is solely for that purpose and that the invention is not limited to the disclosed preferred and non-limiting embodiments, examples, or aspects, but, on the contrary, is intended to cover modifications and equivalent arrangements that are within the spirit and scope of the appended claims. For example, it is to be understood that the present invention contemplates that, to the extent possible, one or more features of any preferred and non-limiting embodiment, example, or aspect can be combined with one or more features of any other preferred and non-limiting embodiment, example, or aspect.

The invention claimed is:

1. An eddy current tester comprising:
a probe assembly including:
a plurality of coils;
a first module; and
an enclosure housing the plurality of coils and the first module, wherein the first module includes a first processor or controller, a driver connected between the first processor or controller and a first subset of the coils, and receiver connected between the first processor or controller and a second subset of the coils, and the enclosure is configured to be received in a tube under inspection;
a second module including a second processor or controller; and
a cable coupled between the probe assembly and the second module, wherein the first processor or controller is operative:
for receiving from the second processor or controller via the cable one or more digital command signals that cause the first processor or controller to control the driver to supply analog signals to the first subset of coils and that cause the first processor or controller to sample a digital output of the receiver corresponding to analog signals produced by the second subset of coils in response to the analog signals supplied to the first subset of coils; and
for communicating to the second processor or controller via the cable digital data corresponding to the sampled digital output of the receiver, wherein the first subset of coils can be the same or different than the second subset of coils.

2. The eddy current tester of claim 1, wherein, when the enclosure is received in the tube under inspection, the supplied analog signals induce eddy currents in the material forming the tube and the produced analog signals correspond to the induced eddy currents.

3. The eddy current tester of claim 1, wherein all analog signals for inducing eddy currents in a material and resulting from the induced eddy currents are generated and produced in the probe assembly.

4. The eddy current tester of claim 1, wherein all electrical power used by the probe assembly is provided to the probe assembly from a power supply of the second module via the cable.

5. The eddy current tester of claim 1, wherein in response to the one or more digital command signals the first processor or controller samples the digital output of the receiver one or more times.

6. The eddy current tester of claim 1, wherein in response to the one or more digital command signals the first processor or controller is operative for periodically sampling the digital output of the receiver a plurality of times.

7. The eddy current tester of claim 1, a length of the cable separating the probe assembly and the second module is at least 10 meters.

8. The eddy current tester of claim 1, wherein the corresponding digital data comprises digital eddy current data.

9. The eddy current tester of claim 1, wherein, at least one of the following:
the driver includes one or more digital-to-analog converters; and
the receiver includes one or more analog-to-digital converters.

10. A method of eddy current testing comprising:
(a) providing a probe assembly that includes a coil module and a tester module;
(b) inserting the entire probe assembly into a tube under inspection;
(c) supplying by the tester module to the coil module analog signals that induce eddy currents in the tube under inspection;
(d) receiving by the tester module from the coil module analog signals produced in response to the induced eddy currents; and
(e) converting by the tester module the received analog signals into corresponding digital data.

11. The method of claim 10, wherein step (e) includes the tester module converting the received analog signals into corresponding digital data periodically.

12. The method of claim 10, wherein step (e) includes the tester module converting the received analog signals into corresponding digital data aperiodically.

13. The method of claim 10, wherein step (c) occurs in response to the tester module receiving at least one digital command signal from a second module disposed outside of the tube via a cable that runs at least partially in the tube between the tester module and the second module.

14. The method of claim 13, further including receiving the corresponding digital data at the second module from the tester module via the cable.

15. The method of claim 14, further including processing, by the second module, the corresponding digital data into eddy current data corresponding to the induced eddy currents.

16. The method of claim 10, further including processing the corresponding digital data into eddy current data corresponding to the induced eddy currents.

17. The method of claim 16, wherein the processing of the corresponding digital data into eddy current data occurs at least partially at the tester module.

18. The method of claim 17, wherein the processing of the corresponding digital data into eddy current data occurs at least partially at a second module disposed outside of the tube and coupled to the tester module via a cable that runs at least partially in the tube between the tester module and the second module.

19. The method of claim 10, wherein the tester module includes:
a digital-to-analog converter (DAC) for inducing the eddy currents;
an analog-to-digital convertor (ADC) for converting the received analog signal into the corresponding digital data; and
a processor or controller for controlling the operation of the DAC and the ADC and for communicating digitally with a second module disposed outside of the tube and coupled in communication with the tester module via a cable that runs at least partially in the tube between the tester module and the second module.

20. The method of claim 19, wherein electrical power for operation of the tester module comes via the cable from a power supply of the second module.

21. The method of claim 10, wherein electrical power for operation of the tester module comes from a power supply disposed outside of the tube via a cable that runs at least partially in the tube between the tester module and the power supply.

22. A method of eddy current testing comprising:
(a) providing a probe assembly, including a first processor or controller and a plurality of coils, coupled in communication with a module, including a second processor or controller, via a cable;
(b) inserting the probe assembly and a portion of the cable into a tube to be inspected while the module is disposed outside the tube;
(c) in response to a command from the second processor or controller, the first processor or controller, via the plurality of coils, inducing eddy currents in the material forming the tube and acquiring data corresponding to the induced eddy currents; and
(d) processing, by at least one of the first processor or controller and the second processor or controller, the acquired data into eddy current data.

23. The method of claim 22, further including displaying the eddy current data on a display.
